(19) United States
(12) Patent Application Publication
(10) Pub. No.: US 2026/0005266 A1
(43) Pub. Date: Jan. 1, 2026

(54) FUEL CELL

(71) Applicant: TOYOTA JIDOSHA KABUSHIKI KAISHA, Toyota-shi (JP)

(72) Inventors: Tohru ODA, Toyota-shi (JP); Takami UMEDA, Miyoshi-shi (JP); Kyosuke HAYASHI, Toyota-shi (JP)

(73) Assignee: TOYOTA JIDOSHA KABUSHIKI KAISHA, Toyota-shi (JP)

(21) Appl. No.: 19/052,411

(22) Filed: Feb. 13, 2025

(30) Foreign Application Priority Data
Jun. 26, 2024 (JP) 2024-103049

(51) Int. Cl. H01M 8/0263; H01M 8/1004

(52) U.S. Cl. CPC H01M 8/0263; H01M 8/1004

(57) ABSTRACT

A fuel cell disclosed in the present specification includes a membrane electrode assembly, a separator adjacent to the membrane electrode assembly, and a gas channel through which fuel gas, oxygen gas, or air passes. The gas channel is provided on a face of the separator, the face facing the membrane electrode assembly. The gas channel has a wave shape extending in a lateral direction while meandering in an up-down direction. The gas channel includes an upward convex curved portion and a downward convex curved portion that are alternately connected. The downward convex curved portion is shorter than the upward convex curved portion. By making the downward convex curved portion shorter than the upward convex curved portion, water remaining in the downward convex curved portion is easily blown downstream by the force of the gas. That is, the amount of water remaining in the gas channel can be reduced.

### CROSS-REFERENCE TO RELATED APPLICATION

This application claims priority to Japanese Patent Application No. 2024-103049 filed on Jun. 26, 2024. The disclosure of the above-identified application, including the specification, drawings, and claims, is incorporated by reference herein in its entirety.

### BACKGROUND

### 1. Technical Field

The technique disclosed in the present specification relates to a fuel cell including a separator provided with a gas channel.

### 2. Description of Related Art

A fuel cell includes a membrane electrode assembly including a pair of electrodes and an electrolyte membrane sandwiched between the electrodes, and a separator adjacent to the membrane electrode assembly. The membrane electrode assembly may be abbreviated to MEA.

The separator is provided with a gas channel on its face facing the membrane electrode assembly. Hydrogen gas flows through the gas channel facing a negative electrode, and oxygen gas or air flows through the gas channel facing a positive electrode. In fuel cells disclosed in Japanese Unexamined Patent Application Publication No. 2019-186052 (JP 2019-186052 A) and Japanese Unexamined Patent Application Publication No. 2019-175834 (JP 2019-175834 A), the gas channel extends in a wave shape in the lateral direction while meandering in the up-down direction.

### SUMMARY

The gas (hydrogen gas, oxygen gas, or air) flowing through the gas channel contains water vapor. Part of the water vapor in the gas liquefies inside the gas channel. Although most of the water inside the gas channel is discharged from an outlet due to the force of the gas, some of the water remains in troughs of the wavy gas channel. The present specification provides a structure that can reduce the amount of water remaining in troughs of a wavy gas channel included in a separator of a fuel cell.

A fuel cell disclosed in the present specification includes a membrane electrode assembly, a separator adjacent to the membrane electrode assembly, and a gas channel through which fuel gas, oxygen gas, or air passes. The gas channel is provided on a face of the separator, the face facing the membrane electrode assembly. The gas channel has a wave shape extending in a lateral direction while meandering in an up-down direction. The gas channel includes an upward convex curved portion convexly curved upward and a downward convex curved portion convexly curved downward that are alternately connected. The downward convex curved portion is shorter than the upward convex curved portion. By making the downward convex curved portion shorter than the upward convex curved portion, water remaining in the downward convex curved portion is easily blown downstream by the force of the gas. That is, the amount of water remaining in the gas channel can be reduced.

An example of the specific shape of the gas channel is as follows. The upward convex curved portion of the gas channel follows a curve of a sine wave having a pitch A and an amplitude B from 0 degrees to 180 degrees in angle. The downward convex curved portion of the gas channel follows a curve of a sine wave having a pitch C and an amplitude D from 180 degrees to 360 degrees in angle. A>C and B>D are satisfied.

A downstream end (the downstream end in the gas flowing direction) of the wavy gas channel may end at the upward convex curved portion. With such a structure, no water remains at the downstream end of the gas channel.

The separator may include a plurality of gas channels. For example, the gas channel includes a first gas channel, and a second gas channel adjacent to the first gas channel vertically below the first gas channel. In this case, it is preferable to have the following structural features. Each of the first gas channel and the second gas channel has a straight extending portion horizontally extending from the downstream end (the downstream end in the gas flowing direction) of the wavy portion of the gas channel. The first gas channel and the second gas channel are coupled through a coupling channel, the coupling channel extending obliquely downward along a flow of gas from the straight extending portion of the first gas channel to the straight extending portion of the second gas channel. With such a structure, water discharged from the first gas channel reliably flows downstream.

The details and further improvements of the technique disclosed in the present specification are described in “DETAILED DESCRIPTION OF EMBODIMENTS” below.

### BRIEF DESCRIPTION OF THE DRAWINGS

Features, advantages, and technical and industrial significance of exemplary embodiments of the invention will be described below with reference to the accompanying drawings, in which like signs denote like elements, and wherein:

FIG. 1 is an exploded perspective view of a fuel cell of an embodiment; and

FIG. 2 is a plan view of a separator.

### DETAILED DESCRIPTION OF EMBODIMENTS

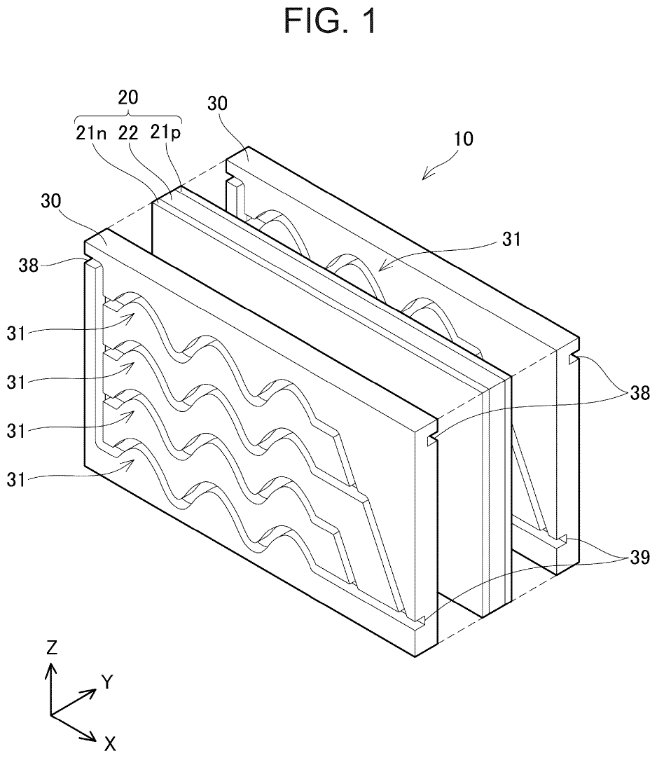

A fuel cell 10 of an embodiment will be described with reference to the drawings. FIG. 1 is an exploded perspective view of the fuel cell 10. The fuel cell 10 includes a membrane electrode assembly 20 (MEA 20), and a separator 30. As described above, “MEA” is an abbreviation for “membrane electrode assembly”. The MEA 20 has a structure including a pair of electrodes (a positive electrode layer 21p and a negative electrode layer 21n), and an electrolyte membrane 22 sandwiched between the electrodes. Each electrode contains a catalyst layer that accelerates reactions.

The separator 30 is adjacent to each face of the MEA 20. The fuel cell 10 includes a plurality of MEAs 20, and a plurality of separators 30. The MEAs 20 and the separators 30 are alternately stacked one by one. FIG. 1 shows only a pair of separators 30, and one MEA 20 sandwiched between the separators 30.

Although the fuel cell 10 includes various components in addition to the MEAs 20 and the separators 30, illustration and description of the components are omitted. A stack of the MEAs 20 and the separators 30 may be referred to as a fuel cell stack in a narrow sense.

The separator 30 has electrical conductivity, corrosion resistance, and gas impermeability. The separator 30 is typically made of a carbon-based material and a metal-based material.

The separator 30 is provided with a wavy gas channel 31 on its face facing the MEA 20. As described above, the MEAs 20 are disposed on both faces of the separator 30. Thus, the separator 30 is provided with the gas channel 31 on each of the faces of the separator 30. The gas channel 31 is a groove provided on the separator 30. By the separator 30 being joined with the MEA 20, an upper opening of the groove is closed, and the gas flows in one direction. Oxygen gas (or air) is passed through the gas channel 31 facing the positive electrode layer 21p of the MEA 20, and hydrogen gas is passed through the gas channel 31 facing the negative electrode layer 21n. The gas is fed through a gas inlet 38, part of the gas is used in reaction, and the rest of the gas is discharged through a gas outlet 39. The gas flowing through the gas channel 31 diffuses into the catalyst layer (electrode) of the MEA 20 and reacts in the catalyst layer. The direction in which the gas flows in the gas channel 31 provided on a first face of the separator 30 is opposite to the direction in which the gas flows in the gas channel 31 provided on a second face of the separator 30. The gas inlet 38 (the gas inlet 38 of the gas channel 31 provided on the first face of the separator 30) and the gas outlet 39 (the gas outlet 39 of the gas channel 31 provided on the second face of the separator 30) are provided on one side face of the separator 30.

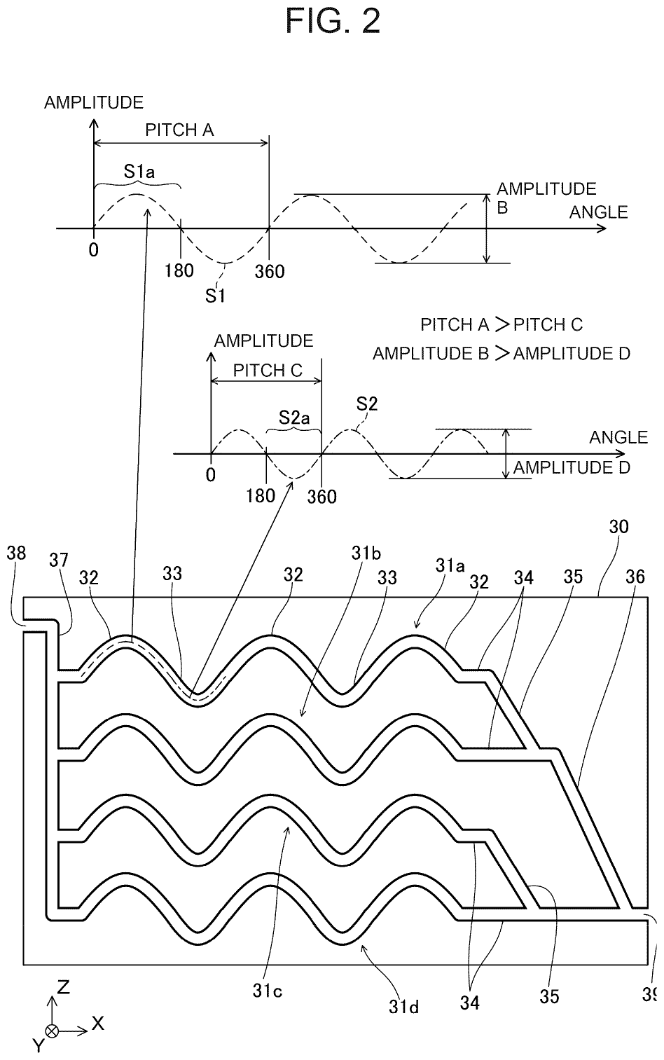

As will be described further below, the gas channel 31 includes an upward convex curved portion 32, and a downward convex curved portion 33. However, reference numerals (31, 32) for these portions are not shown in FIG. 1. The upward convex curved portion 32 and the downward convex curved portion 33 are shown in FIG. 2.

In a coordinate system of FIG. 1, a +Z-direction corresponds to the vertically upward direction. An XY plane corresponds to the horizontal plane. A +X-direction corresponds to the direction in which the gas channel 31 extends. The meaning of each axis of the coordinate system is the same as that in FIG. 2.

FIG. 2 is a plan view of the separator 30. FIG. 2 is also a diagram of the separator 30 viewed from the direction of the normal of its wide face. The separator 30 in FIG. 2 has four gas channels 31. For convenience of description, the four gas channels may be referred to as gas channels 31a, 31b, 31c, and 31d from top to bottom in the vertical direction. When all the four gas channels are described without distinction, the gas channels are referred to as the gas channels 31.

Each gas channel 31 includes a portion (wavy portion) having a wave shape when viewed in the horizontal direction, an introduction channel 37 that connects the gas inlet 38 to the wavy portion, and a straight extending portion 34 and coupling channels 35, 36 that connect the wavy portion to the gas outlet 39.

The wavy portion extends in the lateral direction (horizontal direction) while meandering up and down when viewed in the horizontal direction. For convenience of description, the wavy portion of the gas channel 31 is divided into the upward convex curved portion 32 that is convexly curved upward (vertically upward) when viewed in the horizontal direction, and the downward convex curved portion 33 that is convexly curved downward (vertically downward) when viewed in the horizontal direction. The wavy portion of the gas channel 31 includes a plurality of upward convex curved portions 32, and a plurality of downward convex curved portions 33. The upward convex curved portions 32 and the downward convex curved portions 33 are alternately connected one by one. In FIG. 2, only the gas channel 31a is shown with reference numeral 32 (upward convex curved portions) and reference numeral 33 (downward convex curved portions), and the other gas channels 31b to 31d are shown without reference numerals 32, 33.

The curve of the upward convex curved portion 32 and the curve of the downward convex curved portion 33 both follow a sine wave. However, the length of the downward convex curved portion 33 is shorter than the length of the upward convex curved portion 32. As shown in FIG. 2, the upward convex curved portion 32 follows a curve Sla of a sine wave S1 having a pitch A and an amplitude B from 0 degrees to 180 degrees in angle. The downward convex curved portion 33 follows a curve S2a of a sine wave S2 having a pitch C and an amplitude D from 180 degrees to 360 degrees in angle. A vertical axis of a coordinate system of the sine wave coincides with the vertical direction. The pitch A is larger than the pitch C, and the amplitude B is larger than the amplitude D. These relationships ensure that the length of the downward convex curved portion 33 is shorter than the length of the upward convex curved portion 32. In FIG. 2, the unit system for the horizontal axis of the sine wave is angle, and reference characters A, C represent numerical values when the pitch of the sine wave is expressed in length. Reference characters B, D that represent amplitude also have a length dimension.

When the upward convex curved portion 32 and the downward convex curved portion 33 satisfy the relationships of the pitch A>the pitch C and the amplitude B>the amplitude D, the following advantage can be obtained. The gas (hydrogen gas, oxygen gas, or air) flowing through the gas channel 31 contains water vapor. Part of the water vapor liquefies in the gas channel 31. In the gas channel 31, the water accumulates in the troughs of the wavy gas channel 31 (that is, in the downward convex curved portions 33). Although most of the water in the gas channel 31 is discharged from the outlet due to the force of the gas, some of the water remains in the troughs of the wavy gas channel 31. When the relationships of the pitch A>the pitch C and the amplitude B>the amplitude D are satisfied, the water remaining in the downward convex curved portion 33 easily flows over the upward convex curved portion 32 located downstream thereof due to the force of the gas. The gas channel 31 that satisfies the relationships of the pitch A>the pitch C and the amplitude B>the amplitude D can reduce the amount of water that remains in the gas channel 31.

As shown in FIG. 2, a downstream end (the downstream end in the gas flowing direction) of the wavy portion of the gas channel 31 ends at the upward convex curved portion 32. With such a structure, no water remains at the downstream end of the wavy portion.

As shown in FIG. 2, the gas channel 31b is adjacent to the gas channel 31a vertically below the gas channel 31a. Each of the gas channels 31a, 31b has the straight extending portion 34 horizontally extending from the downstream end of the wavy portion. The gas channels 31a, 31b are coupled through the coupling channel 35 that extends obliquely downward along the flow of gas from the straight extending portion 34 of the upper gas channel 31a to the straight extending portion 34 of the lower gas channel 31b. Similarly, the gas channels 31c, 31d are adjacent to each other in the vertical direction. The gas channel 31c is located above the gas channel 31d. Each of the gas channels 31c, 31d has the straight extending portion 34 horizontally extending from the downstream end. The gas channels 31c, 31d are coupled through the coupling channel 35 that extends obliquely downward along the flow of gas from the straight extending portion 34 of the upper gas channel 31c to the straight extending portion 34 of the lower gas channel 31d. Furthermore, the straight extending portion 34 of the gas channel 31b and the straight extending portion 34 of the gas channel 31d are coupled through the coupling channel 36 that extends obliquely downward along the flow of gas from the straight extending portion 34 of the upper gas channel 31b to the straight extending portion 34 of the lower gas channel 31d. The gas outlet 39 is located at a leading end of the straight extending portion 34 of the gas channel 31d that is the lowermost one of the gas channels.

Upstream ends of the gas channels 31a to 31d are connected to the gas inlet 38 through the introduction channel 37. The gas inlet 38 is located above the wavy portion of the uppermost gas channel 31.

Of the two gas channels 31a, 31b that are adjacent to each other in the vertical direction, the upper gas channel 31a may be referred to as the first gas channel, and the lower gas channel 31b may be referred to as the second gas channel. In that case, the coupling structure of the two adjacent gas channels can be described as follows. The first gas channel 31a and the second gas channel 31b are coupled through the coupling channel 35 that extends obliquely downward along the flow of gas from the straight extending portion 34 of the first gas channel 31a to the straight extending portion 34 of the second gas channel 31b. The same applies to the gas channels 31c, 31d. That is, the first gas channel 31c and the second gas channel 31d are coupled through the coupling channel 35 that extends obliquely downward along the flow of gas from the straight extending portion 34 of the first gas channel 31c to the straight extending portion 34 of the second gas channel 31d.

In summary, the features of the fuel cell 10 in the embodiment are as follows. The separator 30 has the wavy gas channel 31. The gas channel 31 is the groove provided on the separator 30. The gas channel 31 has a wave shape that extends in the lateral direction (horizontal direction) while meandering in the up-down direction. In the wavy portion of the gas channel 31, the upward convex curved portions 32 convexly curved upward and the downward convex curved portions 33 convexly curved downward are alternately connected. The downward convex curved portion 33 is shorter than the upward convex curved portion 32.

When viewed along the normal of the separator 30 (the normal of the face having the gas channel 31), the upward convex curved portion 32 follows the curve of the sine wave having the pitch A and the amplitude B from 0 degrees to 180 degrees in angle, the downward convex curved portion 33 follows the curve of the sine wave having the pitch C and the amplitude D from 180 degrees to 360 degrees in angle, and A>C and B>D are satisfied. In other words, the pitch A is longer than the pitch C, and the amplitude B is larger than the amplitude D. Thus, the downward convex curved portion 33 is shorter than the upward convex curved portion 32. In other words, the upward convex curved portion 32 has a shape convexly curved vertically upward, and the downward convex curved portion 33 has a shape convexly curved vertically downward.

A point to note regarding the technique described in the embodiment will be described. The separator 30 may be provided with five or more channels extending parallel to each other.

Although specific examples of the present invention have been described in detail above, these are merely examples and do not limit the scope of the claims. The technique described in the claims includes various modifications and changes of the specific examples described above. The technical elements described in the present specification or the drawings exhibit technical utility alone or in various combinations and are not limited to the combinations described in the claims at the time of filing the application. In addition, the technique exemplified in the present specification or the drawings can achieve multiple objects at the same time, and achieving one of the objects itself has technical utility.

What is claimed is:

1. A fuel cell comprising:
a membrane electrode assembly including
a pair of electrodes, and
an electrolyte membrane sandwiched between the electrodes;
a separator adjacent to the membrane electrode assembly; and
a gas channel provided on a face of the separator, the face facing the membrane electrode assembly, wherein:
the gas channel has a wave shape extending in a lateral direction while meandering in an up-down direction;
the gas channel includes an upward convex curved portion convexly curved upward and a downward convex curved portion convexly curved downward that are alternately connected; and
the downward convex curved portion is shorter than the upward convex curved portion.

2. The fuel cell according to claim 1, wherein:
the upward convex curved portion follows a curve of a sine wave having a pitch A and an amplitude B from 0 degrees to 180 degrees in angle;
the downward convex curved portion follows a curve of a sine wave having a pitch C and an amplitude D from 180 degrees to 360 degrees in angle; and
A>C and B>D are satisfied.

3. The fuel cell according to claim 1, wherein a downstream end of a wavy portion of the gas channel ends at the upward convex curved portion.

4. The fuel cell according to claim 3, wherein:
the gas channel includes
a first gas channel, and
a second gas channel adjacent to the first gas channel vertically below the first gas channel;
each of the first gas channel and the second gas channel has a straight extending portion horizontally extending from the downstream end; and
the first gas channel and the second gas channel are coupled through a coupling channel, the coupling channel extending obliquely downward along a flow of gas from the straight extending portion of the first gas channel to the straight extending portion of the second gas channel.
